(19) United States
(12) Patent Application Publication
(10) Pub. No.: US 2020/0026423 A1
(43) Pub. Date: Jan. 23, 2020

(54) TOUCH DISPLAY PANEL AND MANUFACTURING METHOD THEREOF

(71) Applicant: Wuhan China Star Optoelectronics Semiconductor Display Technology Co., Ltd., Wuhan (CN)

(72) Inventor: Jian YE, Wuhan (CN)

(73) Assignee: Wuhan China Star Optoelectronics Semiconductor Display Technology Co., Ltd., Wuhan (CN)

(21) Appl. No.: 16/092,003

(22) PCT Filed: Aug. 10, 2018
(86) PCT No.: PCT/CN2018/099786

§ 371 Date: Oct. 8, 2018

(30) Foreign Application Priority Data
Jul. 20, 2018 (CN) 201810803250.7

(51) Int. Cl. G06F 3/0488; G06F 3/047; G06F 3/041; G06F 1/16

(52) U.S. Cl. CPC G06F 3/04886; G06F 1/1643; G06F 3/0412; G06F 3/047

(57) ABSTRACT

An touch display panel and a manufacturing method thereof are disclosed, and include a display panel comprising a touch region and a non-touch region; a plurality of touch electrodes are disposed corresponding to the touch region, and a plurality of leads connected to the touch electrodes are disposed corresponding to a bezel portion of the non-touch region; the leads are wiring by a manner of overlapped or partially overlapped of upper and lower layers, or fully spaced apart; and the leads at the upper and lower layers are separated by an insulation layer to achieve a narrow bezel.

### FIELD OF INVENTION

The present disclosure relates to the technical field of touch display screens, and specifically to a touch display panel and a manufacturing method thereof.

### BACKGROUND OF INVENTION

Because full-screen mobile phones are being increasingly favored by consumer customers, a screen occupation ratio of a whole touch display module of a mobile phone is also increasing. Touch screens and display screens are required to be narrower and narrower.

Regarding traditional touch sensors, whether they belong to an external type, or an Oncell/Incell integrated into the display, touch electrodes in the visible region usually are made of a transparent conductive film (ITO). A signal wiring of a pattern of the ITO electrodes in a connection surface usually is a metal wiring, which is located in a peripheral region around the pattern of the touch electrodes. Thus, a corresponding wiring region around the pattern of the touch electrodes in a manufacturing process is left to lay the metal wiring. However, a width of the wiring region is a key factor for determining a bezel size of the entire touch display module. A metal wiring manner of the existing touch sensors reduces the screen occupation ratio due to a larger width of the wiring region, thereby reducing the width of the wiring region being essential to achieve a full surface screen.

Therefore, It is necessary to provide a touch display panel and a method of manufacturing the same to solve the problems of the prior art.

### SUMMARY OF INVENTION

An objective of the present disclosure is to provide a touch display panel and a manufacturing method thereof, which enable to reduce a width of a bezel of the touch display panel to realize a narrow bezel of the touch display panel, which is beneficial to realize a design of a full surface screen.

In order to resolve the above problem, technical solutions are provided by the present disclosure as follows.

A touch display panel is provided in the present disclosure, and includes:

a display panel including a touch region and a non-touch region around the touch region, wherein a binding region is defined in the non-touch region;
a first metal layer, an insulation layer, and a second metal layer are sequentially stacked on the display panel;
one of the first metal layer and the second metal layer is forming a plurality of conductive bridges and a plurality of first leads after a patterning process, wherein the conductive bridges correspond to the touch region and distributed in an array manner, the first leads are arranged on two sides of the touch region, and one end of each of the first leads extends to the binding region;
the other one of the first metal layer and the second metal layer is forming a plurality of touch electrodes and a plurality of second leads after another patterning process, wherein the touch electrodes correspond to the touch region, the second leads are arranged at the two sides of the touch region, and one end of each of the second leads extends to the binding region;
the insulation layer is provided with a plurality of first contact holes corresponding to two ends of each of the conductive bridges and a plurality of second contact holes corresponding to the other end of each of the first leads;
wherein the touch electrodes and the conductive bridges are shaped as metal meshes;
wherein the touch electrodes are defined into a plurality of first electrode chains and a plurality of second electrode chains, the first electrode chains and the second electrode chains are independent from each other, the touch electrodes belonging to the first electrode chains are connected via the conductive bridges through the first contact holes, a part of the second electrode chains are connected to the first leads through the second contact holes, and rest of the second electrode chains are connected to the other end of each of the second leads; and wherein the first leads and the second leads are mutually overlapped or misplaced, and are electrically insulated.

According to a preferred embodiment of the present disclosure, the second electrode chains are integrally formed during the patterning process for the first metal layer or the second metal layer, and the first electrode chains are intersected with the second electrode chains.

According to a preferred embodiment of the present disclosure, a number of the first leads and a number of the second leads both arranged at the two sides of the touch region are equal.

According to a preferred embodiment of the present disclosure, the first metal layer further comprises a plurality of third leads arranged on one side of the touch region close to the binding region, one end of each of the third leads is connected to one of the first electrode chains through a third contact hole at the insulation layer, and the other end of each of the third leads extends to the binding region.

According to a preferred embodiment of the present disclosure, the second metal layer further comprises a plurality of third leads arranged on one side of the touch region close to the binding region, one end of each of the third leads is connected to one of the first electrode chains, and the other end of each of the third leads extends to the binding region.

A manufacturing method of a touch display panel is further provided, and includes: a step S10, providing a display panel to be manufactured with a plurality of touch electrodes, the display panel comprising a touch region and a non-touch region around the touch region, wherein a binding region is defined in the non-touch region;

a step S20, manufacturing a first metal layer on the display panel, forming a plurality of conductive bridges distributed in an array manner in the touch region and a plurality of first leads arranged on two sides of the touch region after a patterning process, wherein one end of each of the first leads extends to the binding region;
a step S30, manufacturing an insulation layer, forming a plurality of first contact holes and a plurality of second contact holes both in the insulation layer after another patterning process, wherein the first contact holes correspond to two ends of each of the conductive bridges, and the second contact holes correspond to the other end of each of the first leads;
a S40 step, manufacturing a second metal layer, forming the touch electrodes in the touch region and a plurality of second leads on two sides of the touch region after another patterning process, wherein the touch electrodes are defined into a plurality of first electrode chains and a plurality of second electrode chains, the first electrode chains and the second electrode chains are independent from each other and intersected, one end of all of the second leads is connected to one of a part of the second electrode chain, and the other end of all of the second leads extends to the binding region; and
wherein the touch electrodes belonging to the first electrode chains are connected via the conductive bridges through the first contact holes, rest of the second electrode chains are connected to the first leads through the second contact holes, and the first leads and the second leads are mutually overlapped or misplaced.

According to a preferred embodiment of the present disclosure, the conductive bridges and the first leads are formed by a photomask process.

According to a preferred embodiment of the present disclosure, the touch electrodes and the second leads are formed by a photomask process.

According to a preferred embodiment of the present disclosure, a number of the first leads and a number of the second leads both arranged at the two sides of the touch region are equal.

A touch display panel is further provided, and includes:

a display panel comprising a touch region and a non-touch region around the touch region, wherein a binding region is defined in the non-touch region;
a first metal layer, an insulation layer, and a second metal layer sequentially stacked on the display panel;
one of the first metal layer and the second metal layer forming a plurality of conductive bridges and a plurality of first leads after a patterning process, wherein the conductive bridges correspond to the touch region and distributed in an array manner, the first leads are arranged on two sides of the touch region, and one end of each of the first leads extends to the binding region;
the other one of the first metal layer and the second metal layer forming a plurality of touch electrodes and a plurality of second leads after another patterning process, wherein the touch electrodes correspond to the touch region, the second leads are arranged at the two sides of the touch region, and one end of each of the second leads extends to the binding region;
the insulation layer provided with a plurality of first contact holes corresponding to two ends of each of the conductive bridges and a plurality of second contact holes corresponding to the other end of each of the first leads;
wherein the touch electrodes are defined into a plurality of first electrode chains and a plurality of second electrode chains, the first electrode chains and the second electrode chains are independent from each other, the touch electrodes belonging to the first electrode chains are connected via the conductive bridges through the first contact holes, a part of the second electrode chains are connected to the first leads through the second contact holes, and rest of the second electrode chains are connected to the other end of each of the second leads; and wherein the first leads and the second leads are mutually overlapped or misplaced, and are electrically insulated.

According to a preferred embodiment of the present disclosure, the second electrode chains are integrally formed during the patterning process for the first metal layer or the second metal layer, and the first electrode chains are intersected with the second electrode chains.

According to a preferred embodiment of the present disclosure, a number of the first leads and a number of the second leads both arranged at the two sides of the touch region are equal.

According to a preferred embodiment of the present disclosure, the first metal layer further comprises a plurality of third leads arranged on one side of the touch region close to the binding region, one end of each of the third leads is connected to one of the first electrode chains through a third contact hole in the insulation layer, and the other end of each of the third leads extends to the binding region.

According to a preferred embodiment of the present disclosure, the second metal layer further comprises a plurality of third leads arranged on one side of the touch region close to the binding region, one end of each of the third leads is connected to one of the first electrode chains, and the other end of each of the third leads extends to the binding region.

A beneficial effect of the present disclosure is as follows: the touch control display panel and the manufacturing method thereof provided by the present disclosure are implemented by arranging the leads of the bezel of the touch display panel divided into two layers of overlap, or partial overlap, or completely spaced off, and separating the two layers of upper and lower leads from the insulation layer. Thus, the width of the bezel of the touch display panel can be effectively reduced, and the bezel the touch display panel can be narrowed, so as to realize the design of the full surface screen. Furthermore, the conductive bridges and the first leads formed by a photomask process and the touch electrodes integrated formed with the second leads enable to simplify the present technical solutions and will not increase production costs.

### BRIEF DESCRIPTION OF DRAWINGS

In order to more clearly illustrate the embodiments or the technical solutions in the prior art, the drawings to be used in the embodiments or the prior art description will be briefly described below. Obviously, the drawings in the following description are merely some embodiments of the present disclosure. Other drawings can be obtained on the basis of these drawings without the need for creative labor from those of ordinary skill in the art.

FIG. 1 is a structural schematic of a traditional touch display panel.

FIG. 2 is a flowchart of a manufacturing method of a touch display panel provided in an embodiment of the present disclosure.

FIGS. 3A to 3C are schematic plan views of different film layers of the touch display panel provided in the embodiments of the present disclosure.

### DETAILED DESCRIPTION OF PREFERRED EMBODIMENTS

The following description of each embodiment refers to the appended drawings for illustrating specific embodiments in which the present disclosure may be practiced. Directional terms as mentioned in the present disclosure, such as “up”, “down”, “front”, “rear”, “left”, “right”, “inside”, “outside”, “lateral”, etc., are merely used for the purpose of illustrating and understanding the present disclosure and are not intended to limit the present disclosure. In the drawings, units with similar structures are denoted by the same reference numerals.

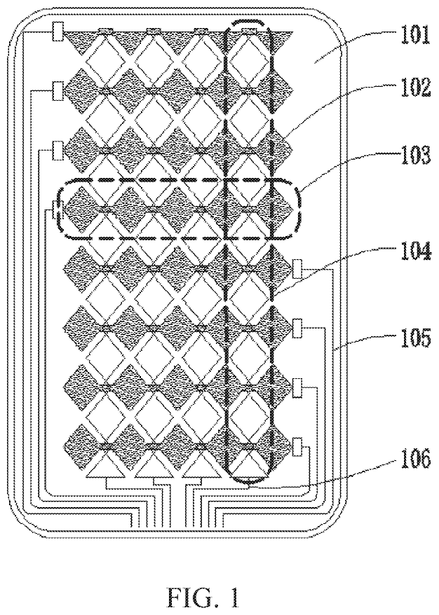

Referring to FIG. 1, which is a structural schematic of a traditional touch display panel. The touch display panel has provided with a plurality of touch electrodes 102 on a display panel 101. The touch electrodes 102 are defined into a plurality of first electrode chains 103, a plurality of second electrode chains 104, a plurality of first leads 105 and a plurality of second leads 106 manufactured on a layer the same with the touch electrodes 102, wherein one of the first leads 105 is used to connect one of the first electrode chains 103, and one of the second leads 106 is used to connect one of the second electrode chains 104. Since two adjacent of the first leads 105 and the second leads 106 need to insulate each other, an edge of the display panel 101 needs to leave a corresponding region for wiring. Although the first leads 105 are uniformly distributed to edge positions on both sides as much as possible, this wiring manner still forms a wider wiring region, thereby reducing the screen occupation ratio.

The present disclosure is directed to the touch display panel of the prior art, the present embodiment can solve the defect because the metal wiring manner of the bezel portion forms a wider wiring region, thereby reducing the technical problem of the screen occupation ratio.

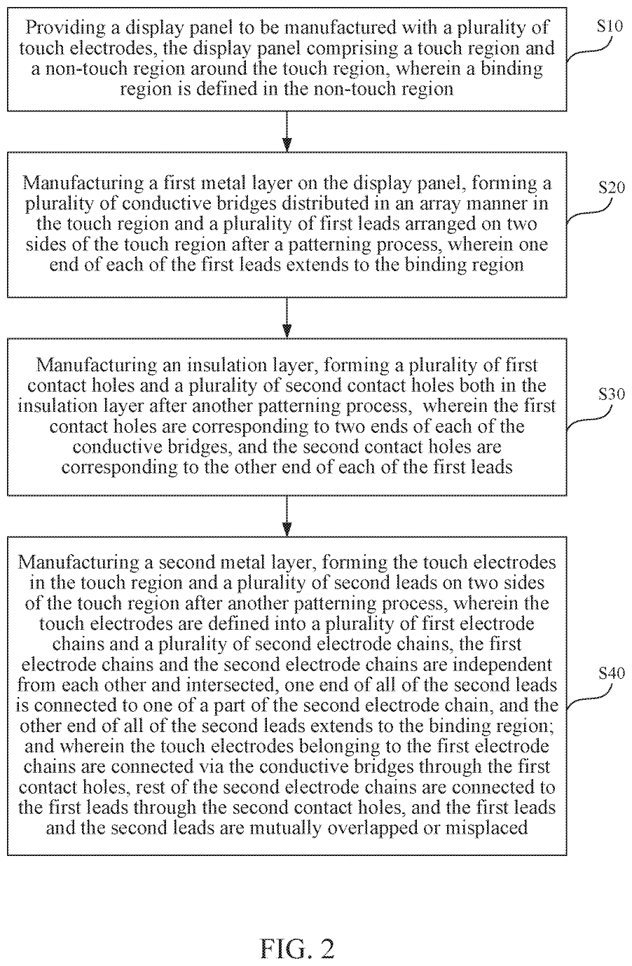

Referring to FIG. 2, which is a flowchart of a manufacturing method of a touch display panel provided in an embodiment of the present disclosure. The manufacturing method of the touch display panel comprises the following steps:

A step S10 is providing a display panel to be manufactured with a plurality of touch electrodes, the display panel including a touch region and a non-touch region around the touch region, wherein a binding region is defined in the non-touch region.

Specifically, an active matrix organic light emitting diode (AMOLED) display panel is provided for manufacturing the touch electrodes, wherein a thin film packaging layer is formed on a surface of the AMOLED display panel. The AMOLED display panel includes the touch region for manufacturing the touch electrodes and the non-touch region around the touch region. The non-touch region is used to route a plurality of leads connecting the touch electrodes, wherein a binding region is further defined in the non-touch region. The leads may extend to the binding region.

A step S20 is manufacturing a first metal layer on the display panel, forming a plurality of conductive bridges distributed in an array manner in the touch region and a plurality of first leads arranged on two sides of the touch region after a patterning process, wherein one end of each of the first leads extends to the binding region.

Specifically, the first metal layer is firstly formed as a whole surface on the thin film packaging layer by a method of physical vapor deposition, wherein materials of the first metal layer may be metal materials such as Titanium (Ti)/Aluminum (Al)/Ti, or Molybdenum (Mo)/Copper (Cu)/Silver (Ag) and alloys thereof, which do not be restricted here. Then, the conductive bridges distributed in the array manner in the touch region and the first leads arranged on two sides of the touch region are formed on the first metal layer, which has been patterned by a yellow light etching (dry etching) process. The first leads are used to connect to a part of the touch electrodes, wherein one end of each of the first leads extends to the binding region, the other end of each of the first leads extends to a preset position of an edge of the touch region. Two adjacent of the first leads are electrically insulated. Preferably, the conductive bridges and the first leads are formed by a photomask process.

A step S30 is manufacturing an insulation layer, forming a plurality of first contact holes and a plurality of second contact holes both in the insulation layer after another patterning process, wherein the first contact holes correspond to two ends of each of the conductive bridges, and the second contact holes correspond to the other end of each of the first leads.

Specifically, the insulation layer is firstly formed as a whole transparent surface on the first metal layer by a method of chemical vapor deposition, wherein a material of the insulation layer is an inorganic material such as SiNx or SiO2. Then the first contact holes and the second contact holes both are formed in the insulation layer, which has been patterned by another yellow light etching (dry etching) process, wherein the first contact holes correspond to two ends of each of the conductive bridges, and the second contact holes correspond to the end of each of the first leads close to the edge of the touch region.

A S40 step is manufacturing a second metal layer, forming the touch electrodes in the touch region and a plurality of second leads on two sides of the touch region after another patterning process, wherein the touch electrodes are defined into a plurality of first electrode chains and a plurality of second electrode chains, the first electrode chains and the second electrode chains are independent from each other and intersected, one end of all of the second leads is connected to one of a part of the second electrode chain, and the other end of all of the second leads extends to the binding region.

Specifically, the second metal layer is firstly formed as a whole surface on the insulation layer by a method of physical vapor deposition, wherein materials of the second metal layer may be metal materials such as Ti/Al/Ti, or Mo/Cu/Ag and alloys thereof. Then, the touch electrodes and the second leads are formed on the second metal layer, which has been patterned by another yellow light etching (dry etching) process. Wherein the touch electrodes are defined into a plurality of first electrode chains and a plurality of second electrode chains, the first electrode chains are longitudinally connected via the conductive bridges through the first contact holes, the second electrode chains are directed and transversely connected through the second contact holes. The first electrode chains and the second electrode chains are independent from each other and are disposed at intersection.

A part of the second electrode chains are connected to the first leads through the second contact holes, and rest of the second electrode chains are electrically connected to the second leads formed together with the rest of the second electrode chains. The first leads and the second leads are used to electrically connect to the second electrode chains, one of the first leads or the second leads correspondingly connects one of the second electrode chains. The first leads and the second leads are manufactured on different film layers, and may be fully overlapped or partial overlapped, or fully misplaced. The first leads and the second leads are used to transmit signals over the second electrode chains to a control terminal.

Preferably, the touch electrodes and the second leads are formed by a photomask process.

Preferably, the first leads and the second leads are misplaced, thereby reducing a resistive, capacitive loading (RC Loading) between the first leads and the second leads.

Additionally, the second metal layer further includes a plurality of third leads, which are formed together with the second leads and the touch electrodes, and are located on one side of the non-touch region close to the binding region. One end of each of the third leads is connected to one of the first electrode chains, and the other end of each of the third leads extends to the binding region.

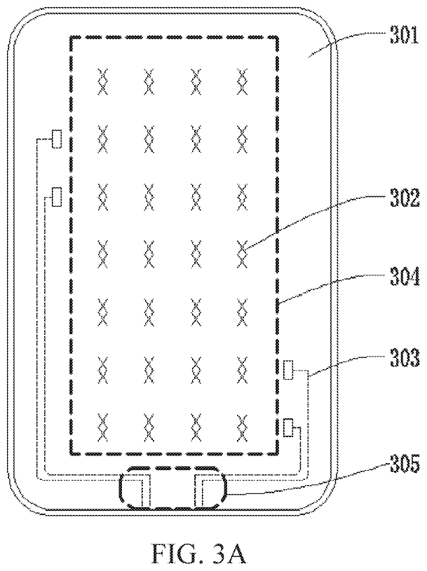

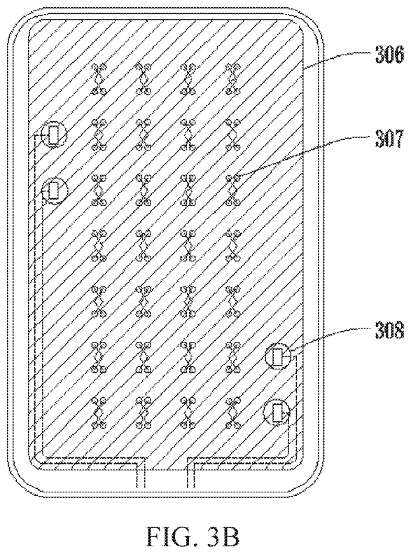

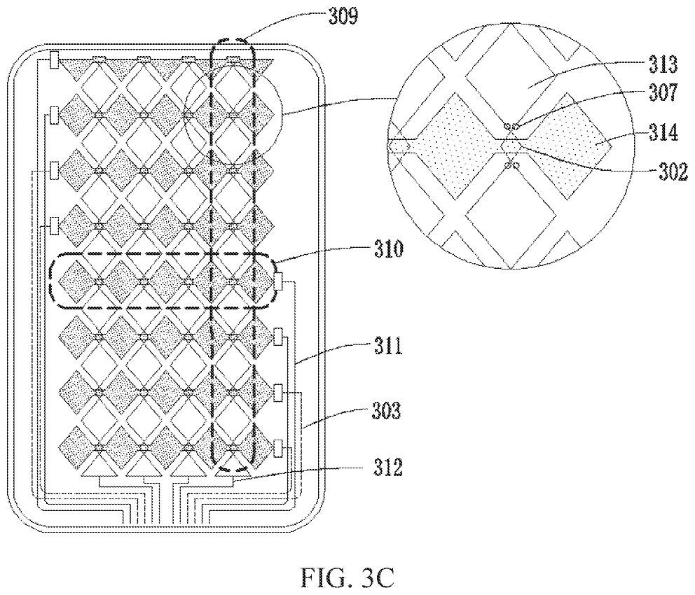

The present disclosure also provides a touch display panel, referring to FIGS. 3A to 3C, which are schematic plan views of different film layers of the touch display panel provided in the embodiments of the present disclosure. The touch display panel includes a display panel 301 including a touch region 304 and a non-touch region around the touch region 304, wherein a binding region 305 is defined in the non-touch region; a first metal layer disposed on the display panel 301, wherein the first metal layer includes a plurality of conductive bridges 302 and a plurality of first leads 303, the conductive bridges 302 are located in the touch region and distributed in an array manner, the first leads 303 are arranged on two sides of the touch region 304, and one end of each of the first leads 303 extends to the binding region 305; an insulation layer 306 disposed on the first metal layer, wherein the insulation layer 306 is provided with a plurality of first contact holes 307 corresponding to two ends of each of the conductive bridges 302 and a plurality of second contact holes 308 corresponding to the other end of each of the first leads 303; a second metal layer disposed on the insulation layer 306, wherein the second metal layer includes a plurality of touch electrodes located at the touch region 304 and a plurality of second leads 311 arranged on two sides of the touch region 304, and one end of each of the second leads 311 extends to the binding region 305; and wherein the touch electrodes are defined into a plurality of first electrode chains 309 and a plurality of second electrode chains 310 independent from each other, a plurality of first touch electrodes 313 belonging to the first electrode chains 309 are connected via the conductive bridges 302 through the first contact holes 307, a plurality of the second touch electrodes 314 belonging to the second electrode chains 310 are directly connected via the second metal layer, and the first electrode chains and the second electrode chains are independent from each other and are intersected.

A part of the second electrode chains 310 are connected to the first leads 303 through the second contact holes 308, rest of the second electrode chains 310 are directly connected to the second leads 311, and one of the second electrode chains 310 correspondingly connects to one of the first leads 303 or the second leads 304. Preferably, a number of the first leads 303 and a number of the second leads 304 both arranged at the two sides of the touch region 304 are equal. The first leads 303 and the second leads 304 may mutually overlap, or partial overlap, or misplace in upper and lower layers, and are electrically insulated. Thereby, an area occupied by a wiring located at the bezel may be saved, and a narrow bezel may be realized.

Additionally, the second metal layer further includes a plurality of third leads 312 arranged on one side of the touch region 304 close to the binding region 305, one end of each of the third leads 312 is connected to one of the first electrode chains 309, and the other end of each of the third leads 312 extends to the binding region 305. The third leads 312 are integrally formed with the second leads 311 and the touch electrodes, and the third leads 312 are electrically insulated from the second leads 311.

Alternatively, the first metal layer includes a plurality of third leads 312 arranged on one side of the touch region 304 close to the binding region 305, one end of each of the third leads 312 is connected to one of the first electrode chains 309 through a third contact hole in the insulation layer 306, and the other end of each of the third leads 312 extends to the binding region 305. The third leads 312 are integrally formed with the second leads 311 and the conductive bridges 302, and the third leads 312 electrically insulated from the first leads 303.

Capacitors may be formed between the first touch electrodes 313 belonging to the first electrode chains 309 and the second touch electrode 314 belonging to the second electrode chains 310 adjacent to the first touch electrodes 313. The first leads 303, the second leads 311, and the third leads 312 jointly transmit touch signals generated by the touch electrodes to the control terminal.

Preferably, the touch electrodes and the conductive bridges 302 are shaped as metal meshes.

It can be understood that, the patterning process interchange between the first metal layer and the second metal layer in the present solution can also achieve the object of the present disclosure. That is, one of the first metal layer and the second metal layer forming the conductive bridges corresponding to the touch region and the first leads located on two sides of the touch region after one patterning process, the other one of the first metal layer and the second metal layer forming the touch electrodes corresponding to the touch region and the second leads located at the two sides of the touch region after another patterning process. Then, the first electrode chains are connected to the conductive bridges, a part of the second electrode chains are connected to the first leads, and rest of the second electrode chains are connected to the second leads. The purpose of the present disclosure may be achieved. A specific patterning process may be referenced with the above embodiments, and details are not described herein again.

The touch control display panel and the manufacturing method thereof provided by the present disclosure are implemented by arranging the leads of the bezel of the touch display panel divided into two layers of overlap, or partial overlap, or completely spaced off, and separating the two layers of upper and lower leads from the insulation layer. Thus, the width of the bezel of the touch display panel can be effectively reduced, and the bezel the touch display panel can be narrowed, so as to realize the design of the full surface screen. Furthermore, the conductive bridges and the first leads formed by a photomask process and the touch electrodes integrated formed with the second leads enable to simplify the present technical solutions and will not increase production costs.

In summary, although the present disclosure has been disclosed in the preferred embodiments, the above preferred embodiments are not intended to limit the present disclosure. Those skilled in the art may make various changes and modifications without departing from the spirit and scope of the present disclosure. Therefore, the protection scope of the present disclosure is based on the scope defined by the claims.

What is claimed is:

1. A touch display panel, comprising:
a display panel comprising a touch region and a non-touch region around the touch region, wherein a binding region is defined in the non-touch region;
a first metal layer, an insulation layer, and a second metal layer sequentially stacked on the display panel;
one of the first metal layer and the second metal layer forming a plurality of conductive bridges and a plurality of first leads after a patterning process, wherein the conductive bridges correspond to the touch region and distributed in an array manner, the first leads are arranged on two sides of the touch region, and one end of each of the first leads extends to the binding region;
the other one of the first metal layer and the second metal layer forming a plurality of touch electrodes and a plurality of second leads after another patterning process, wherein the touch electrodes correspond to the touch region, the second leads are arranged at the two sides of the touch region, and one end of each of the second leads extends to the binding region;
the insulation layer provided with a plurality of first contact holes corresponding to two ends of each of the conductive bridges and a plurality of second contact holes corresponding to the other end of each of the first leads;
wherein the touch electrodes and the conductive bridges are shaped as metal meshes;
wherein the touch electrodes are defined into a plurality of first electrode chains and a plurality of second electrode chains, the first electrode chains and the second electrode chains are independent from each other, the touch electrodes belonging to the first electrode chains are connected via the conductive bridges through the first contact holes, a part of the second electrode chains are connected to the first leads through the second contact holes, and rest of the second electrode chains are connected to the other end of each of the second leads; and
wherein the first leads and the second leads are mutually overlapped or misplaced, and are electrically insulated.

2. The touch display panel as claimed in claim 1, wherein the second electrode chains are integrally formed during the patterning process for the first metal layer or the second metal layer, and the first electrode chains are intersected with the second electrode chains.

3. The touch display panel as claimed in claim 1, wherein a number of the first leads and a number of the second leads both arranged at the two sides of the touch region are equal.

4. The touch display panel as claimed in claim 1, wherein the first metal layer further comprises a plurality of third leads arranged on one side of the touch region close to the binding region, one end of each of the third leads is connected to one of the first electrode chains through a third contact hole at the insulation layer, and the other end of each of the third leads extends to the binding region.

5. The touch display panel as claimed in claim 1, wherein the second metal layer further comprises a plurality of third leads arranged on one side of the touch region close to the binding region, one end of each of the third leads is connected to one of the first electrode chains, and the other end of each of the third leads extends to the binding region.

6. A manufacturing method of a touch display panel, comprising:
a step S10, providing a display panel to be manufactured with a plurality of touch electrodes, the display panel comprising a touch region and a non-touch region around the touch region, wherein a binding region is defined in the non-touch region;
a step S20, manufacturing a first metal layer on the display panel, forming a plurality of conductive bridges distributed in an array manner in the touch region and a plurality of first leads arranged on two sides of the touch region after a patterning process, wherein one end of each of the first leads extends to the binding region;
a step S30, manufacturing an insulation layer, forming a plurality of first contact holes and a plurality of second contact holes both in the insulation layer after another patterning process, wherein the first contact holes correspond to two ends of each of the conductive bridges, and the second contact holes correspond to the other end of each of the first leads;
a S40 step, manufacturing a second metal layer, forming the touch electrodes in the touch region and a plurality of second leads on two sides of the touch region after another patterning process, wherein the touch electrodes are defined into a plurality of first electrode chains and a plurality of second electrode chains, the first electrode chains and the second electrode chains are independent from each other and intersected, one end of all of the second leads is connected to one of a part of the second electrode chain, and the other end of all of the second leads extends to the binding region; and
wherein the touch electrodes belonging to the first electrode chains are connected via the conductive bridges through the first contact holes, rest of the second electrode chains are connected to the first leads through the second contact holes, and the first leads and the second leads are mutually overlapped or misplaced.

7. The manufacturing method as claimed in claim 6, wherein the conductive bridges and the first leads are formed by a photomask process.

8. The manufacturing method as claimed in claim 6, wherein the touch electrodes and the second leads are formed by a photomask process.

9. The manufacturing method as claimed in claim 6, wherein a number of the first leads and a number of the second leads both arranged at the two sides of the touch region are equal.

10. A touch display panel, comprising:
a display panel comprising a touch region and a non-touch region around the touch region, wherein a binding region is defined in the non-touch region;
a first metal layer, an insulation layer, and a second metal layer sequentially stacked on the display panel;
one of the first metal layer and the second metal layer forming a plurality of conductive bridges and a plurality of first leads after a patterning process, wherein the conductive bridges correspond to the touch region and distributed in an array manner, the first leads are arranged on two sides of the touch region, and one end of each of the first leads extends to the binding region;
the other one of the first metal layer and the second metal layer forming a plurality of touch electrodes and a plurality of second leads after another patterning process, wherein the touch electrodes correspond to the touch region, the second leads are arranged at the two sides of the touch region, and one end of each of the second leads extends to the binding region;
the insulation layer provided with a plurality of first contact holes corresponding to two ends of each of the conductive bridges and a plurality of second contact holes corresponding to the other end of each of the first leads;
wherein the touch electrodes are defined into a plurality of first electrode chains and a plurality of second electrode chains, the first electrode chains and the second electrode chains are independent from each other, the touch electrodes belonging to the first electrode chains are connected via the conductive bridges through the first contact holes, a part of the second electrode chains are connected to the first leads through the second contact holes, and rest of the second electrode chains are connected to the other end of each of the second leads; and
wherein the first leads and the second leads are mutually overlapped or misplaced, and are electrically insulated.

11. The touch display panel as claimed in claim 10, wherein the second electrode chains are integrally formed during the patterning process for the first metal layer or the second metal layer, and the first electrode chains are intersected with the second electrode chains.

12. The touch display panel as claimed in claim 10, wherein a number of the first leads and a number of the second leads both arranged at the two sides of the touch region are equal.

13. The touch display panel as claimed in claim 10, wherein the first metal layer further comprises a plurality of third leads arranged on one side of the touch region close to the binding region, one end of each of the third leads is connected to one of the first electrode chains through a third contact hole in the insulation layer, and the other end of each of the third leads extends to the binding region.

14. The touch display panel as claimed in claim 10, wherein the second metal layer further comprises a plurality of third leads arranged on one side of the touch region close to the binding region, one end of each of the third leads is connected to one of the first electrode chains, and the other end of each of the third leads extends to the binding region.
